(19) United States
(12) Patent Application Publication
(10) Pub. No.: US 2011/0207568 A1
(43) Pub. Date: Aug. 25, 2011

(54) Bi-Directional Belt Tensioner

(76) Inventors: Gary Smith, Youngsville, NC (US); William McCotter, Wilmington, NC (US); Thomas Hughes, Wilmington, NC (US); Carl Cura, Wilmington, NC (US); JoAnne Cura, Wilmington, NC (US); Eric S. Mosser, Palmyra, PA (US); Francis B. Fatato, Exton, PA (US)

(21) Appl. No.: 12/953,288

(22) Filed: Nov. 23, 2010

Related U.S. Application Data
(63) Continuation-in-part of application No. 10/941,445, filed on Sep. 15, 2004, now Pat. No. 7,883,436.
Application No. 10/941,445 is a continuation-in-part of application No. 10/632,703, filed on Aug. 1, 2003, now Pat. No. 7,837,582.
Application No. 10/632,703 is a continuation-in-part of application No. 10/354,397, filed on Jan. 30, 2003, now Pat. No. 6,855,079.
(60) Provisional application No. 60/414,861, filed on Sep. 30, 2002.

(51) Int. Cl. F16H 7/12

(52) U.S. Cl. 474/135

(57) ABSTRACT

An assembly for maintaining tension in a drive belt features a housing mounted on a base. The housing contains a biasing element that exerts torque on the housing to bias the housing in a radial direction. A lever arm is connected to the housing and rotates with the housing in response to the bias of the biasing element. A pulley is connected to the lever arm and engages a drive belt in response to the bias force of the biasing element on the lever arm. The pulley deflects the shape of the belt to provide tension in the belt. In one embodiment, the apparatus allows the user to switch the position of the biasing element and alter the direction of torque on the lever arm. In another embodiment, the lever arm and pulley are removable from the housing and replaceable with other arms and pulleys having different configurations.

### RELATED APPLICATIONS

This application is a continuation-in-part of co-pending U.S. patent application Ser. No. 10/941,445, filed Sep. 4, 2004 and U.S. patent application Ser. No. 10/632,703, filed Aug. 1, 2003, which is a continuation-in-part of U.S. patent application Ser. No. 10/354,397, filed Jan. 30, 2003, issued as U.S. Pat. No. 6,855,079. This application also claims priority under 35 U.S.C. §119 to U.S. Provisional Application No. 60/414,861, filed Sep. 30, 2002. The entire disclosure of each of the foregoing applications is hereby incorporated herein by reference

### FIELD OF THE INVENTION

The present invention relates generally to belt tensioners, and more specifically to mechanical spring-actuated or biased belt tensioners for use in continuously maintaining tension in endless drive belts in power transmission drive systems.

### BACKGROUND OF THE INVENTION

The known belt tensioners are mostly related to designs that are used in maintaining belt tension in serpentine belt drives for automotive applications. While the majority of the known tensioners pertain to automotive application tensioners, there are other industrial applications where machines have drive systems that have motors driving pulleys with endless belts that need to be tensioned. One example of the prior art is shown in U.S. Pat. No. 4,557,709.

### SUMMARY OF THE INVENTION

The present invention is an assembly for maintaining tension in a drive belt. The assembly features a housing mounted on a fixed base. The housing contains a biasing element having a first end that engages the housing and a second end that engages the base. The biasing element exerts a torque on the housing to bias the housing in a first rotational direction relative to the base. A lever arm is connected to the housing and rotates with the housing in response to the bias of the biasing element. A pulley is connected to the lever arm and is pressed into engagement with the drive belt in response to the bias on the lever arm. The pulley deflects the shape of the belt to provide tension in the belt.

In one embodiment, the apparatus has a modular construction that provides the user with flexibility to assemble the apparatus in a manner that applies torque in either a clockwise or counterclockwise direction. In another embodiment, the device has a multi-part modular construction that allows lever arms and pulleys having different sizes and shapes to be used with the same housing and base. The lever arm, pulley, or both may be removed from the apparatus and replaced with a different sized lever arm and/or pulley to accommodate a different belt drive system or a different tensioning arrangement. Lever arms and pulleys having very simple configurations may be used with the housing and base. As such, the manufacturing costs for the lever arms and pulleys are reduced in comparison to prior art tensioning apparatuses. The housing portion of the modular arm may be constructed with a pivot feature that incorporates ball bearings. The ball bearings reduce the effects of frictional resistance generated when torque is provided in the tensioning apparatus.

The present disclosure also provides a tensioner having a housing and an arm connected with the housing. A biasing element disposed within the housing is operable to bias the arm in a first direction. A base is cooperable with the housing to enclose the biasing element. A shaft extends through the housing and biasing element. The shaft has a bore and a first end configured to mate with the base to impede rotation of the shaft relative to the base while allowing axial displacement of the shaft relative to the base.

### DESCRIPTION OF THE DRAWINGS

The foregoing summary and the following detailed description of the preferred embodiments of the present invention will be best understood when read in conjunction with the appended drawings, in which:

FIG. 1 is a diagram of a typical application, including a belt, tensioner assembly and idler pulley.

FIG. 2 is an exploded perspective view of the present configuration of the belt tensioner assembly shown with a flat belt idler pulley and mounting hardware.

FIG. 3 is a front elevation view of the tensioner without the idler pulley.

FIG. 4 is a side elevational view of the tensioner device shown in FIG. 3.

FIG. 5 is a bottom elevational view of the tensioner device shown in FIG. 3.

FIG. 6 is a sectional view of the device in FIG. 5 taken along the line 6-6.

FIG. 7 is a sectional view of the device in FIG. 3 taken along the line 7-7.

FIG. 8 is a front view of the belt tensioner assembly illustrated in FIG. 2.

FIG. 9 is a side elevational view of the tensioner assembly shown in FIG. 8.

FIG. 10 is a detail showing the housing portion of the design along with the arm. It is the first in a sequence of FIGURES showing the “Bayonet” type of method that connects the arm to the housing. This particular detail shows the arm and the housing in an exploded view, with the tab sections on the arm aligned with the notch sections on the housing. The arrow shows that once the tabs are aligned with the slots, the arm can then be moved down, flush with the housing.

FIG. 11 is the next in the arm/housing assembly sequence, showing the arm with the tabs aligned with the slots in the housing, and with the bottom surface of the arm in contact with the top surface of the housing.

FIG. 12 is the last in the sequence of the arm/housing assembly sequence, showing the arm rotated in a clockwise direction relative to the housing, and the tabs on the arm engaged into the slots in the housing. This sequence can also be achieved in a counter clockwise manner, since the features are mirrored on both sides of the parts.

FIG. 13 is a perspective view of an alternative embodiment of a tensioner.

FIG. 14 is a plan view of the tensioner illustrated in FIG. 13.

FIG. 15 is a sectional view of the tensioner illustrated in FIG. 13.

FIG. 16 is a plan view of a third embodiment of a belt tensioning assembly.

FIG. 17 is a cross-sectional view of to device of FIG. 16, taken along the line 17-17.

FIG. 18 is a partially exploded cross-sectional view of the device of FIG. 17.

FIG. 19 is a partially broken away bottom view of the device of FIG. 16, illustrated without a tensioner arm.

FIG. 20 is a partially broken away bottom view of the device of FIG. 16, illustrating the device with a indicator key inserted in the incorrect position.

FIG. 21 is a partially exploded perspective view of the device of FIG. 20.

FIG. 22 is a diagram of a system illustrating yet another embodiment, including a belt, tensioner assembly and idler pulley.

FIG. 23 is an exploded perspective view of a belt tensioner of the assembly illustrated in FIG. 22

FIG. 24 is a side elevation view of the tensioner illustrated in FIG. 23.

FIG. 25 is a plan view of the tensioner shown in FIG. 23.

FIG. 26 is a cross sectional view of the tensioner of FIG. 25.

FIG. 27 is a sectional view of the device in FIG. 25.

### DETAILED DESCRIPTION

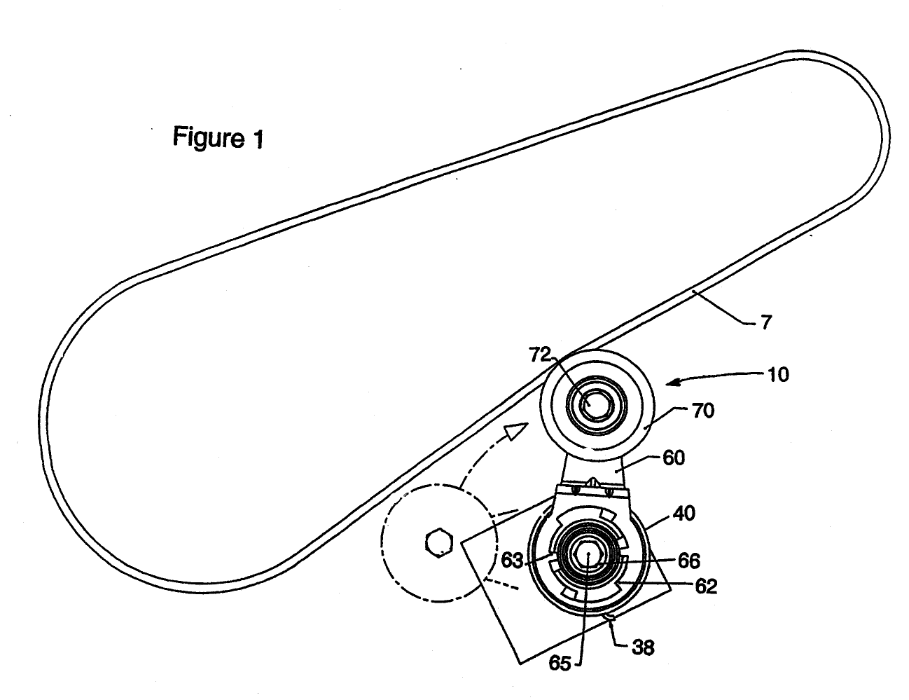

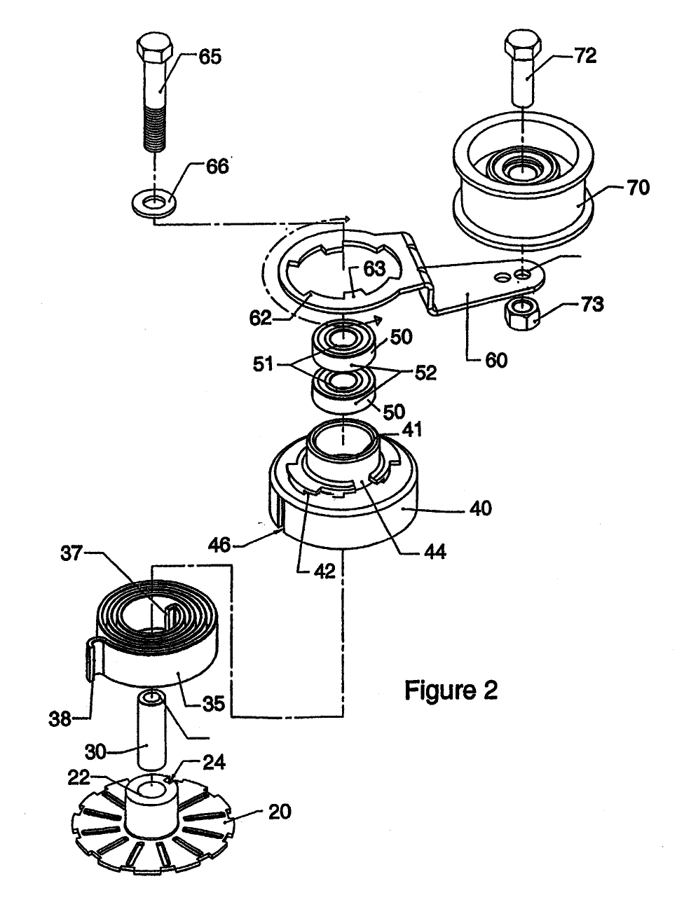

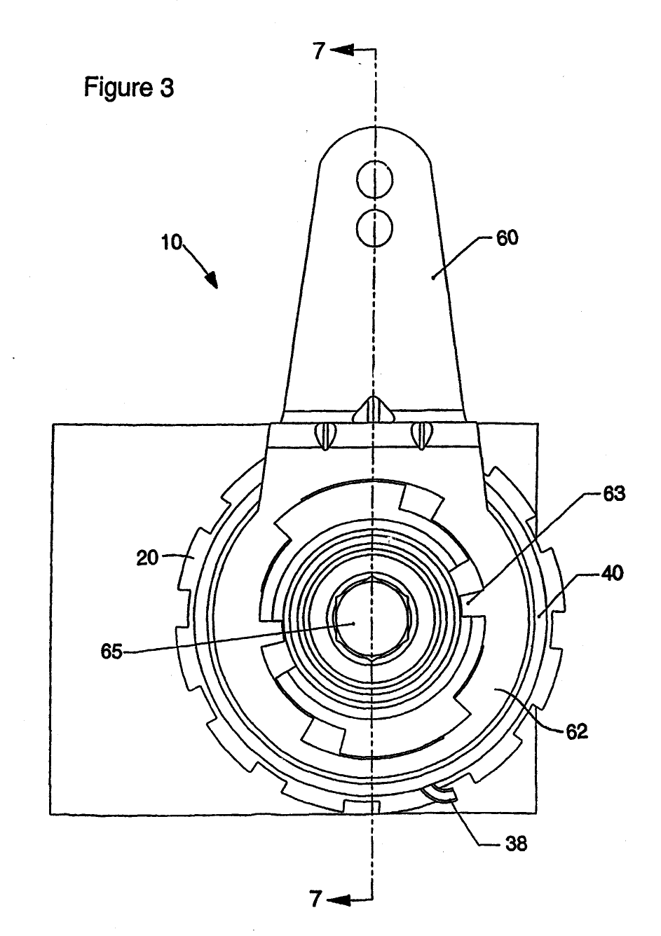

Referring now to the drawings in general, and to FIGS. 1 and 2 specifically, a tensioner apparatus is generally designated 10. The tensioner 10 biases an idler pulley 70 into engagement with a belt 7. The tensioner 10 includes a pivotable arm 60 removably attached to a housing 40. The arm 60 is under bias from a biasing element 35 in the housing 40. The pulley 70 is connected to the end of the arm 60 and engages the belt 7 to apply tension to the belt under the bias from the biasing element 35.

The tensioner 10 has a modular construction that allows the housing 40 to be readily assembled with arms 60 and pulleys 70 having a variety of sizes. As such, the tensioner 10 may be provided as an assembly or kit which comprises a biasing element 35, a housing 40, and a variety of lever arms 60 and pulleys 70 having different sizes. Depending on the application, a lever arm 60 and pulley 70 having appropriate dimensions may be selected and connected to the housing 40.

The modular construction of the tensioner 10 permits easy disassembly and access to the biasing element 35. Referring to FIG. 2, the tensioner 10 comprises a torsion spring 35. The spring 35 is readily removable from the housing 40 and can be reinserted in an opposite or reverse configuration to change the direction of the bias exerted on the lever arm 60.

Referring now to FIG. 2, the details of the tensioner will be described in greater detail. The housing 40 is mounted over a base 20. The base includes a central boss or hub 22 projecting upwardly. The hub 22 is generally cylindrical having a central bore and a vertical slot 24 extending along the height of the hub. The central bore of the base 20 is sized to receive a cylindrical shaft 30. The base 20 is preferably injection molded in a fiber reinforced nylon material. Alternatively, the base could be made using other mold types or manufacturing processes.

The shaft 30 is cylindrical, having a central bore that extends through the shaft. The shaft may be made from a steel tubing, or from a machined from a solid piece of metal, such as steel alloy. The bore through the shaft 30 aligns with the bore in the hub 22 to allow the insertion of a mounting bolt 65.

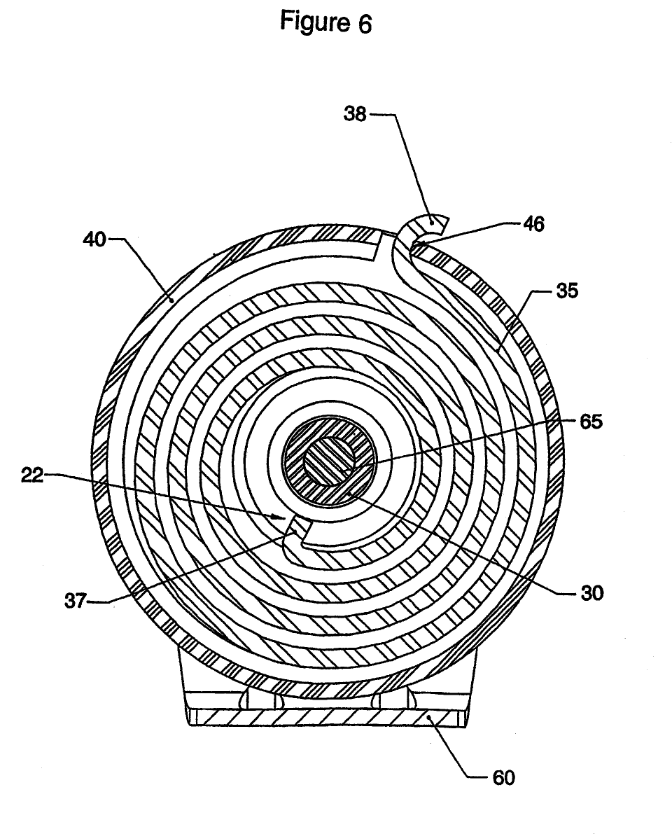

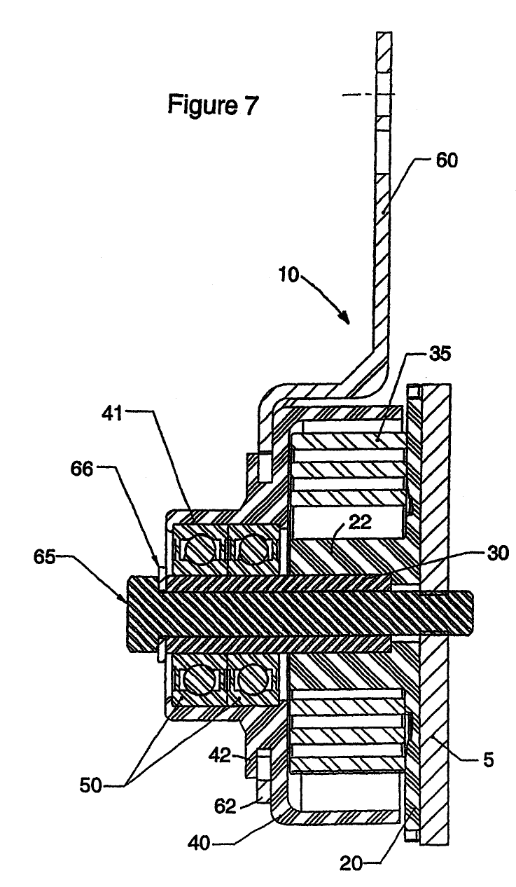

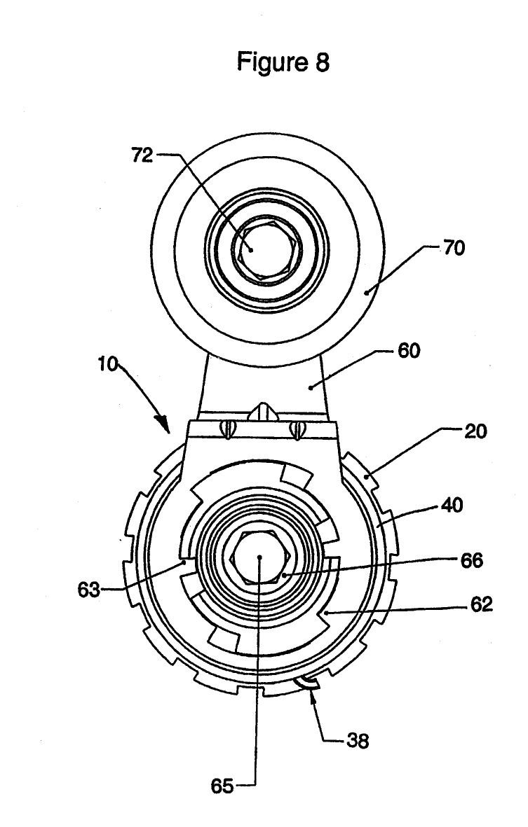

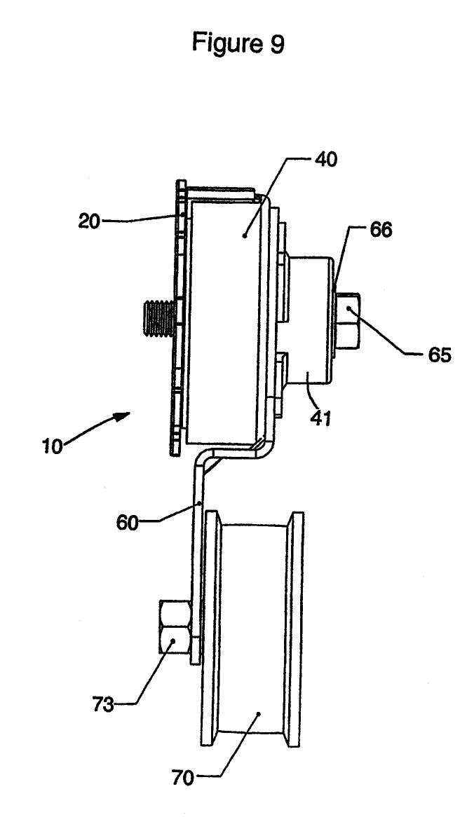

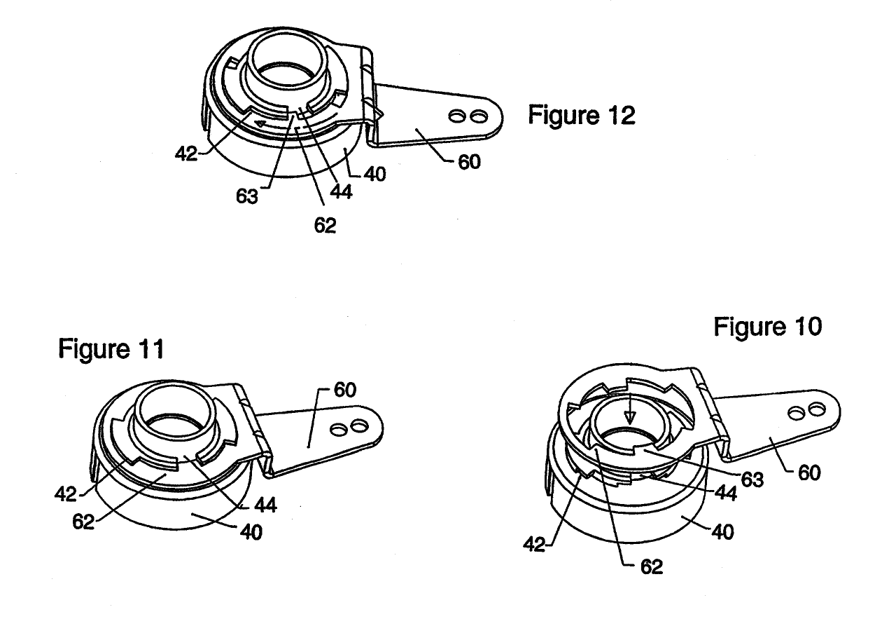

The spring 35 is a spiral spring formed from a long piece of rectangular steel that is formed in a spiral fashion to create a plurality of overlapping convolutions. The inner end 37 of the spring 35 forms a tongue that is inserted into the slot 24 in the hub 22 of the base 20. The outer end 38 of the spring 35 also forms a tongue, which engages the housing 40 as described further below. The inner convolutions of the spring 35 have a diameter that is larger than the outer diameter of the hub 22 so that the spring is disposed around the hub 22, as shown in FIG. 6.

The housing 40 is also preferably injection molded in a fiber reinforced nylon material, however the base could also be made using other manufacturing processes. The housing 40 is generally cylindrical, preferably having a height that is less than its diameter. A vertical opening or slot 46 is formed in the side of the housing 40 and is configured to receive the outer end 38 of the spring 35. The top of the housing 40 includes a locking flange 42 and a gap 44 configured to cooperate with the arm 60 to releasably attach the arm to the housing, as discussed further below.

The housing 40 includes a central hub 41 having an opening in which one or more bearing assemblies 50 are disposed. The bearings 50 are radial ball bearings that can either be pressed into the central bore of the housing to form an interference fit or alternatively can be insert molded into the central bore during the molded process. Although the device is shown in with ball bearings, other types of bearing elements can be used. For instance, a plain bearing, bushing or liner without ball bearings can be used. Accordingly, the term bearings is intended to refer both to bearing elements that have ball bearings, and bearing elements that do not include ball bearings.

The outer race 52 of each bearing is fixed to the central bore of the housing 40. The shaft 30 extends through the bearings 50 so that the inner race 51 of each bearing engages the outer surface of the shaft 30. In this way, the bearings allow the housing 40 to rotate relative to the shaft 30, so that the shaft 30 forms a rotational axis around which the housing rotates.

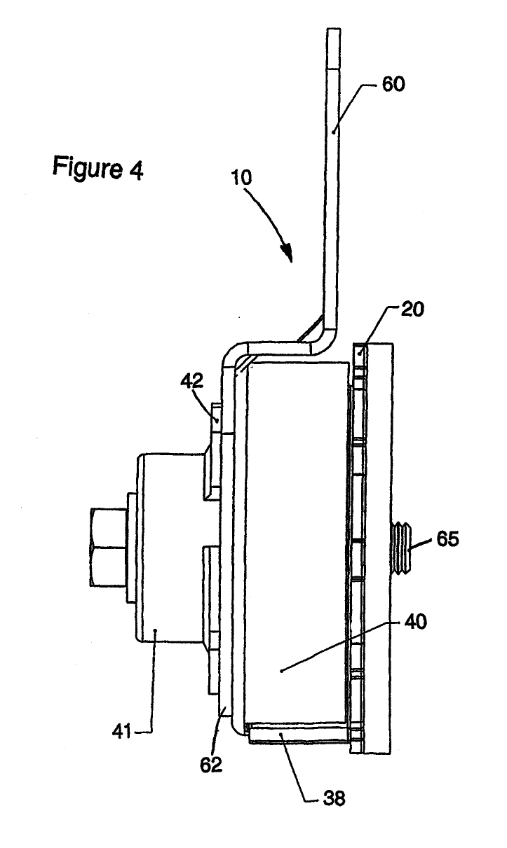

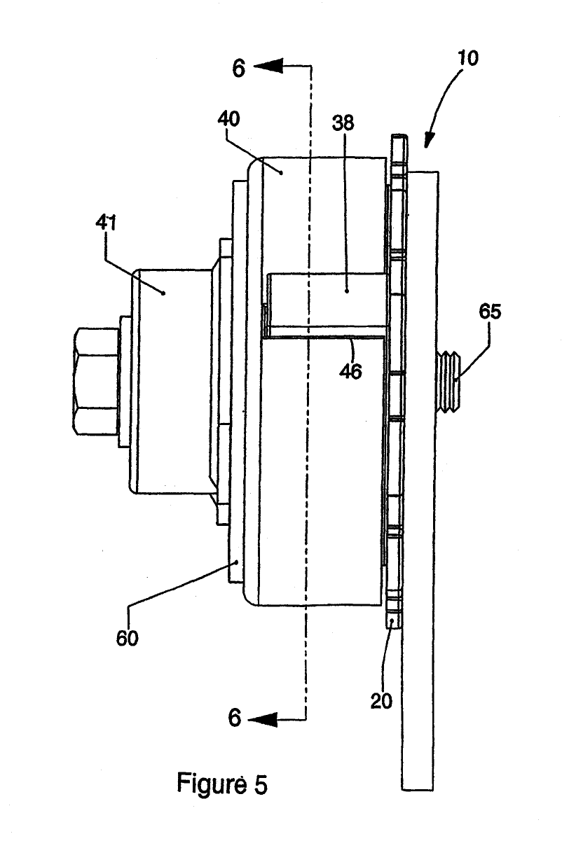

The housing 40 along with the bearings 50 are assembled onto the base 20 by inserting the shaft 30 through the inner race 51 of each bearing 50 while also aligning the slot 46 in the housing with the outer end 38 of the spring 35. The mounting bolt 65 and washer 66 are used to attach the housing 40 to the base. The bolt 65 extends through the bearings 50, the sleeve 30 and the base 20, and into the frame 7 of the device to which the tensioner is mounted. The head of the bolt 65 presses the washer 66 against the end of the shaft 30. In this way, the housing 40 is mounted over the base 20 and the spring 35 so that the housing is rotatable relative to the base. Referring to FIG. 4, the lower edge of the housing 40 is preferably spaced apart from the top surface of the base 20 so that a gap is formed between the housing and the base. The gap allows the housing to readily rotate relative to the base without frictional resistance and consequent wear. Rotating the house in a first direction increases the bias in the spring biasing the housing in a second direction that is reverse the first direction. The bias of the spring can be reversed by flipping over the spring in the housing.

The arm 60 is releasably connected to the housing 40. In this way, different arms of different length and configurations can be attached to the housing. The arm 60 is attached to the housing 40 by means of a bayonet-type connection. Specifically, the arm 60 includes a locking collar 62 that includes a locking tab 63 that cooperates with the locking flange 42 on the housing. The locking tab 63 on the arm is aligned with an opening or gap 44 in the locking flange 42 on the housing and is moved down through the gap and rotated either clockwise or counterclockwise, depending on which way the biasing force is to be applied by the tensioner 10. When the arm is rotated, it slides under a ledge below the flange that retains the locking tabs 63 of the locking collar on the arm. In this way, the locking collar 62 and the locking flange 42 cooperate to retain the arm to impede axial displacement of the arm relative to the housing. Preferably, the mounting configurations on the arm and housing are mirrored. This adds flexibility to connecting the arm and base, with less concern for how the gap 44 is oriented relative to the desired position of the arm 60.

An elongated portion of the arm 60 extends away from the locking collar, and includes a plurality of holes for mounting an idler pulley 70 to the arm. Specifically, the tensioner arm 60 includes one or more holes so that a bolt 72 can pass through the idler pulley 70 and the arm to attach the idler pulley to the arm with a nut 73.

The tensioner assembly 10 may be attached to the frame of a device or onto a mounting assembly attached to a device. Referring to FIG. 1, the tensioner assembly 10 is assembled so as to engage the belt in the position shown (“engaging position”). Before the belt 7 is assembled, the tensioner assembly 10 would typically be assembled with the arm 60 pivoted into a position rotated approximately 90 degrees from the engaging position (such as that shown in phantom lines). This position (“relaxed position”) would not have any biasing load generated by the spring 35 because there would be no deflection in the spring.

When the belt is assembled, the tensioner arm 60 is rotated to the engaging position. During rotation of the arm 60, the housing 40 rotates in a radial direction around the pivot axis. By rotating the housing 40, the outer end 38 of the spring 35 moves in a radial direction because of its connection with the slot 46 in the housing 40. The inner end 37 of the spring remains fixed in contact with the slot 24 in the base 20 while the outer end 38 moves radially. As a result, movement of the outer end 38 of the spring 35 relative to the inner end 37 causes deflection in the spring. The deflection in the spring 35 generates a load which is resisted by a bias force exerted by the spring. In general, the bias force in the spring is proportional to the amount of deflection caused by rotation. The bias force is transferred through the lever arm 60 to the idler pulley 70 at the end of the arm. The idler pulley 70, in turn, pushes on the belt 7 and deflects the shape of the belt. The deflection of the belt form tension and removes the slack in the belt. The biasing force on the arm 60 also causes the bayonet-type attachment of the arm to the housing 40 to remain in engagement.

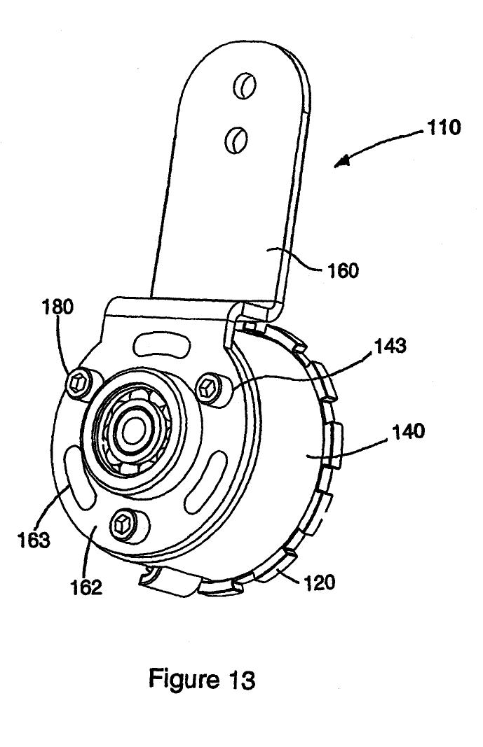

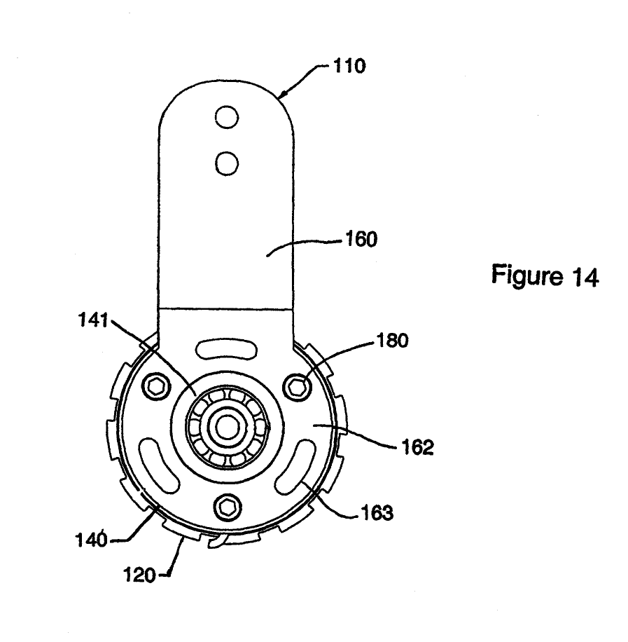

Referring now to FIGS. 13-15, an alternative embodiment of the tensioner is designated generally 110. The tensioner 110 is similar to the embodiment discussed above, and illustrates an alternative connection between the arm and the tensioner housing. Specifically, the tensioner 110 includes a plurality of fasteners, such as nuts 182 and bolts 180 that attach the arm 16 to the housing 140.

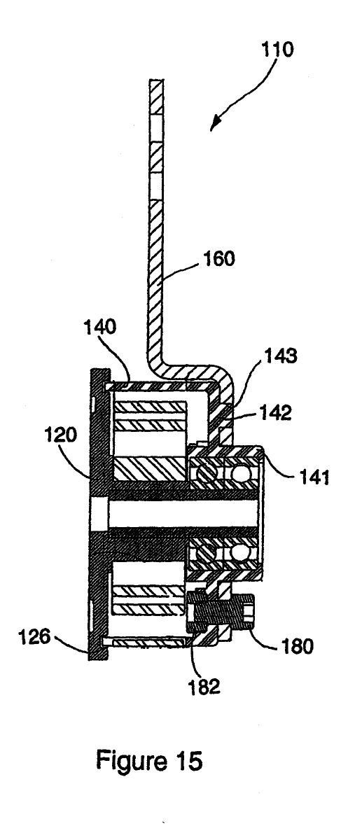

The tensioner 110 includes a base 120 that is similar to the base 20 in the first embodiment previously described. However, preferably, the base 110 includes a circular groove 126 that extends around the periphery of the top surface of the base, as shown in FIG. 15. The groove 126 is configured to receive the lower edge of the housing 140. Preferably, the groove 126 is wider than the thickness of the housing so that the housing can rotate in the groove as the housing is turned relative to the base. In this way, there is a gap between the lower edge of the housing and the bottom of the groove so that the housing can readily pivot relative to the base, but there is not an exposed gap that would allow dirt, dust and other contaminants to easily enter the housing.

The housing 140 is similar to the housing of the first embodiment, except that the housing includes a plurality of pins 142 and holes 143 for aligning and attaching the housing with the arm 160, rather than the locking flange 42 used in the first embodiment. Specifically, the upper surface of the housing 140 includes a plurality of pins 142 projecting upwardly, circumferentially spaced apart around a central hub 141. In addition, the upper surface of the housing includes a plurality of holes 143 circumferentially spaced apart around the central hub.

The arm 160 comprises a locking bracket 162 that includes a plurality of radial slots 163 circumferentially spaced apart. The slots are sized and configured to cooperate with the pins 142 on the top of the housing to align the arm 160 on the housing. In addition, the locking bracket includes a plurality of circumferentially spaced apart holes 164. The locking bracket also includes a central aperture configured to fit over the central hub 141 of the housing.

To attach the arm 160 to the housing 140, the mounting bracket 162 of the arm is placed onto the housing so that the pins 142 on the housing project into the radial slots 163 in the arm, and the holes 164 in the arm are aligned with the holes 143 on the top of the housing. The bolts 180 are then inserted through the aligned holes and threaded into the nuts 182 to attach the arm 160 to the housing 140. The nuts 182 may be inserted into recesses formed inside the housing so that the nuts are attached to the housing. Alternatively, rather than using separate nuts, the holes 143 in the housing can be threaded so that the bolts can be threaded directly into the housing to attach the arm to the housing. In this way, a variety of arms 160 of different lengths and configurations can be used with the same housing and base so that the tensioner can be used in a variety of applications.

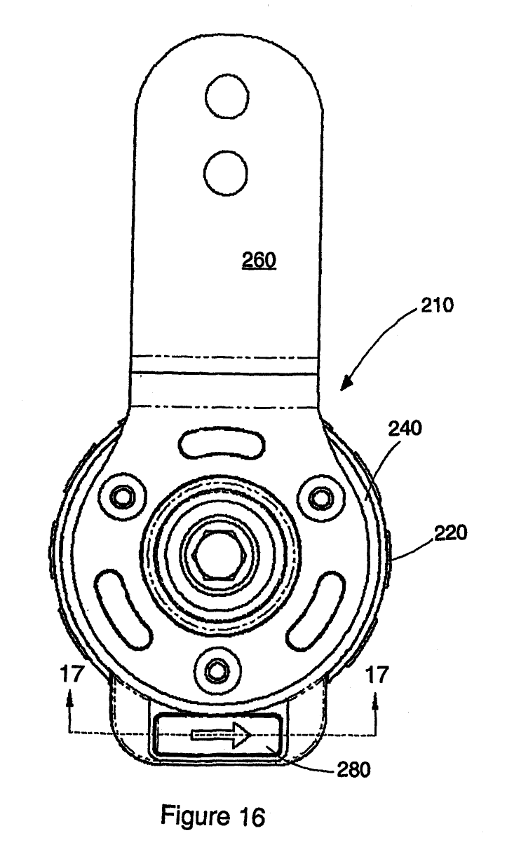

Referring now to FIGS. 16-21 a third embodiment of a tensioner, which is the preferred embodiment, is designated generally 210. The tensioner 210 is similar to the embodiment 110 discussed above, and illustrates an alternative housing having a tensioning indicator 280 to indicate the direction for rotating the device to tension a belt.

The tensioner 210 includes a base 220 that is similar to the base 120 in the second embodiment previously described. Specifically, preferably, the base 210 includes a circular groove that extends around the periphery of the top surface of the base. The groove is configured to receive the lower edge of the housing 240. Preferably, the groove is wider than the thickness of the housing so that the housing can rotate in the groove as the housing is turned relative to the base. In this way, there is a gap between the lower edge of the housing and the bottom of the groove so that the housing can readily pivot relative to the base, but there is not an exposed gap that would allow dirt, dust and other contaminants to easily enter the housing.

The housing 240 is also similar to the housing 140 of the second embodiment, in that the housing includes a plurality of pins and holes for aligning and attaching the housing with the arm 260. Specifically, the upper surface of the housing 140 includes a plurality of pins projecting upwardly, circumferentially spaced apart around a central hub. In addition, the upper surface of the housing includes a plurality of holes circumferentially spaced apart around the central hub. Although the housing and base may be formed of a molded plastic as described previously, preferably the housing 240 and base 220 are formed of metal, such as cast aluminum.

The arm 260 comprises a locking bracket that includes a plurality of radial slots circumferentially spaced apart. The slots are sized and configured to cooperate with the pins on the top of the housing to align the arm 260 on the housing. In addition, the locking bracket includes a plurality of circumferentially spaced apart holes. The locking bracket also includes a central aperture configured to fit over the central hub of the housing.

To attach the arm 260 to the housing 240, the mounting bracket of the arm is placed onto the housing so that the pins on the housing project into the radial slots in the arm, and the holes in the arm are aligned with the holes on the top of the housing. The bolts are then inserted through the aligned holes and threaded into the nuts to attach the arm 260 to the housing 240. In this way, a variety of arms 260 of different lengths and configurations can be used with the same housing and base so that the tensioner can be used in a variety of applications.

As in the previous embodiments, the opposite end of the arm preferably includes an element for attaching a pulley or other element to the end of the arm. Specifically, the arm includes a pair of holes in the opposite end for bolting a pulley to the arm. Preferably, the pulley is attached so that the pulley is rotatable relative to the arm, and is configured to cooperate with the belt to be tensioned. In this way, the pulley provides a rotating interface with the belt as it tensions the belt.

As with the first and second embodiments, the third embodiment 210 includes a biasing element 235, such as a torsion spring. Preferably, the biasing element 235 has one end attached to a shaft and a second end attached to the housing 240, as described above in connection with the first embodiment. Furthermore, as in the first embodiment, preferably the third embodiment includes a bearing disposed between the shaft and the housing so that the housing is readily rotatable relative to the shaft.

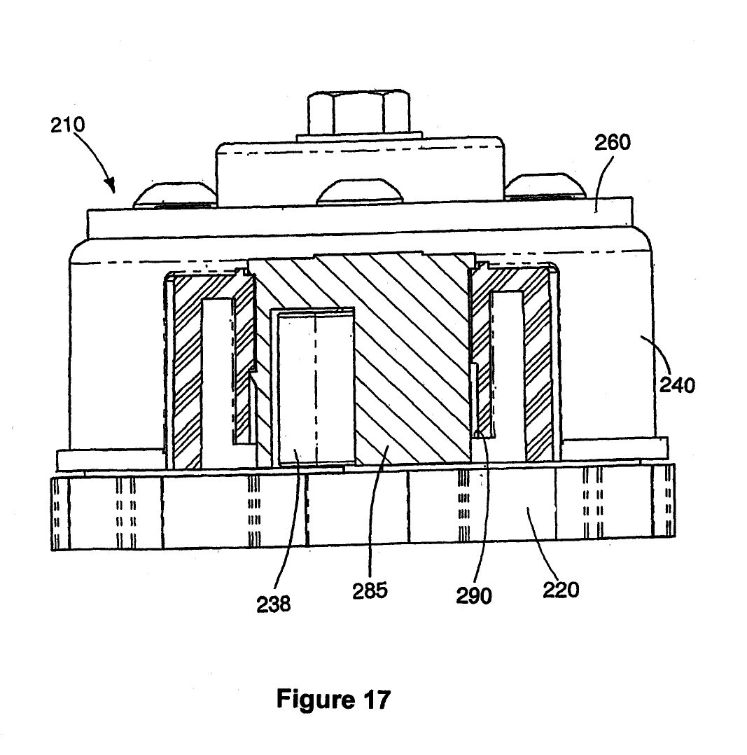

Preferably, the biasing element is reversible so that it can provide a bias in a first direction when it is attached one way, and in a second direction when it is attached in a second way. Specifically, when the spring 235 is attached to the housing and the shaft so that the convolutions run in the direction shown in FIG. 17, the device is operable to provide a counter-clockwise torsional bias (relative to the perspective of FIG. 17) when the housing is turned in a clockwise direction. By flipping the torsion spring over, so that the convolutions run in the opposite direction, the device is operable to provide a clockwise torsional bias when the housing is turned in a counter-clockwise direction.

Since the biasing element 235 is reversible, preferably the device includes an indicator 280 for indicating which direction to turn the housing to provide a bias. Various elements can be used as an indicator. Preferably, the indicator includes an element with a graphical element, such as an arrow or other indicating the proper direction for turning the housing to provide a bias, as shown in FIG. 16.

Referring to FIGS. 16-19, preferably the indicator 280 includes a key or block 285 that is cooperable with a pocket 290 on the housing. The key 285 includes a top surface onto which a graphical indicator is molded or printed. Preferably, the key is configured so that it covers the pocket 290 so that the pocket is enclosed after the key is attached.

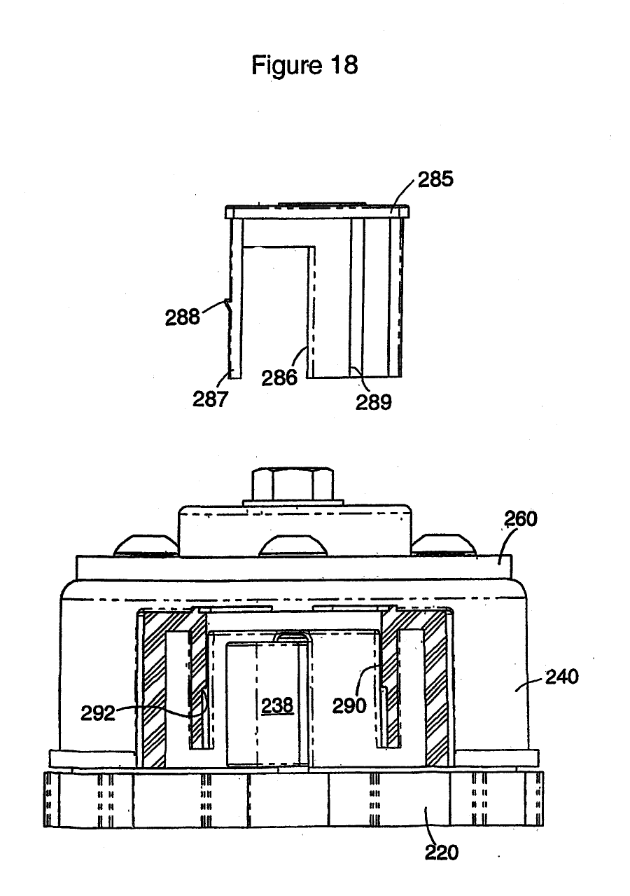

The key 285 includes a recess 286 formed to cooperate with the tongue 238 on the outer end of the spring 235, as discussed further below. One end of the recess is formed by a leg 287 that projects away from the top surface of the key 285. The other side of the recess is formed by a wall 289 having a plurality of ribs, as shown in FIG. 17-18.

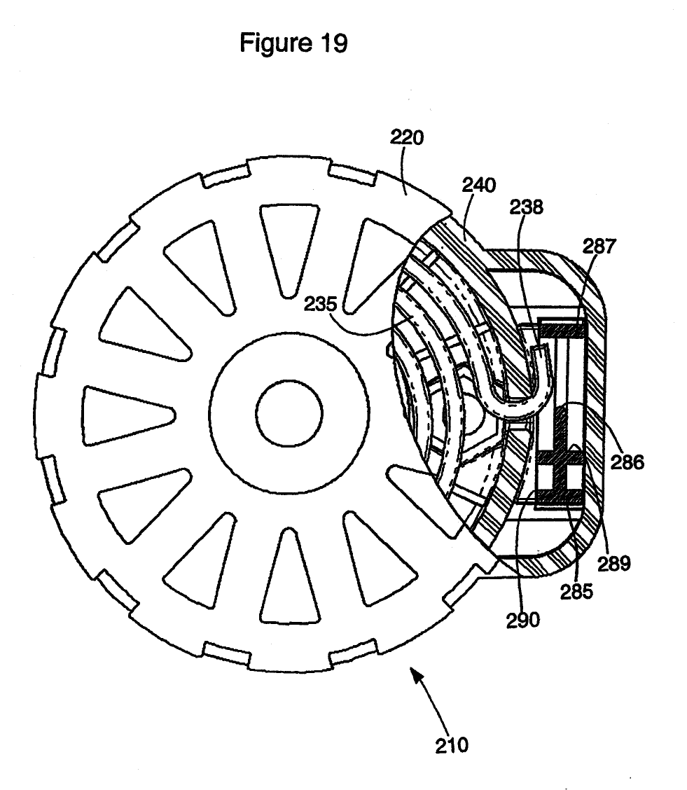

The pocket 290 is configured to cooperate with the key 285. Although the pocket may be separately formed and attached to the housing, preferably, the pocket is integrally formed with the housing as show in FIGS. 16-17. The pocket is formed adjacent to the slot though which the spring 235 projects so that the tongue 238 of the spring projects into the pocket (see FIG. 19).

The key 285 is inserted into the pocket 290 so that the key indicates which direction the housing needs to be turned to tension the device. The key can be formed so that the key can be inserted into the pocket regardless of the orientation of the spring. Specifically, the recess 286 can be formed so that the tongue of the spring 238 does not interfere with the key regardless of the orientation of the spring. Alternatively, the pocket can be located in a position in which the spring does not project into the pocket.

However, if the key can be inserted into the pocket in either orientation regardless of the orientation of the spring, then it is possible to mistakenly insert the key in the wrong orientation, so that the indicator indicates the wrong direction for turning the housing. Therefore, it is desirable to have the key cooperate with a portion of the spring so that the orientation of the spring dictates the orientation of the key. Specifically, preferably the key and pocket are formed so that the tongue 238 of the spring interferes with the key when the key is inserted in the wrong orientation so that the key cannot be improperly inserted into the pocket.

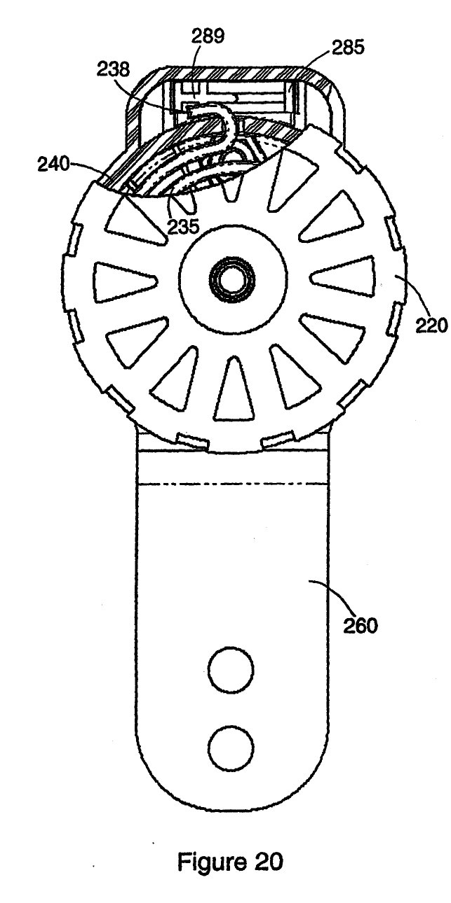

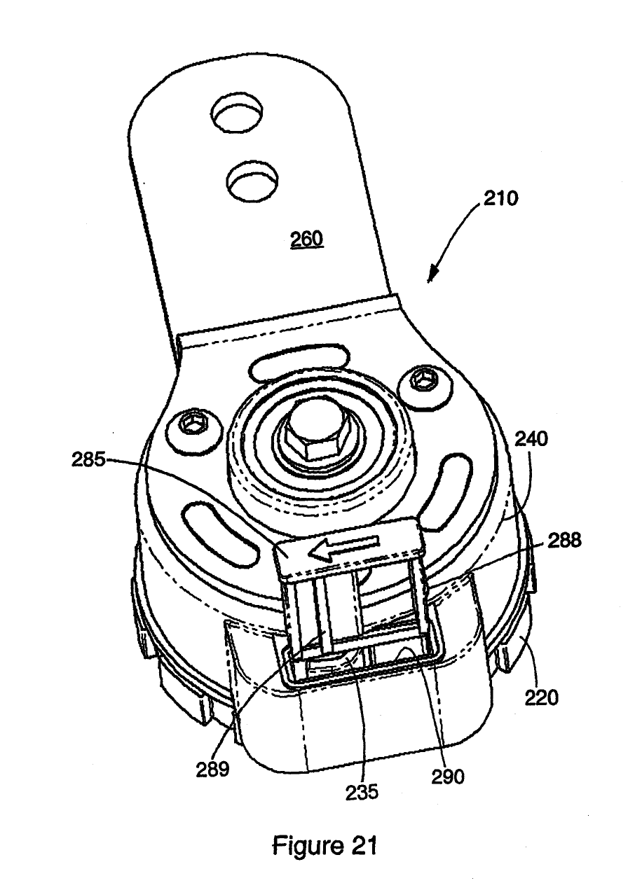

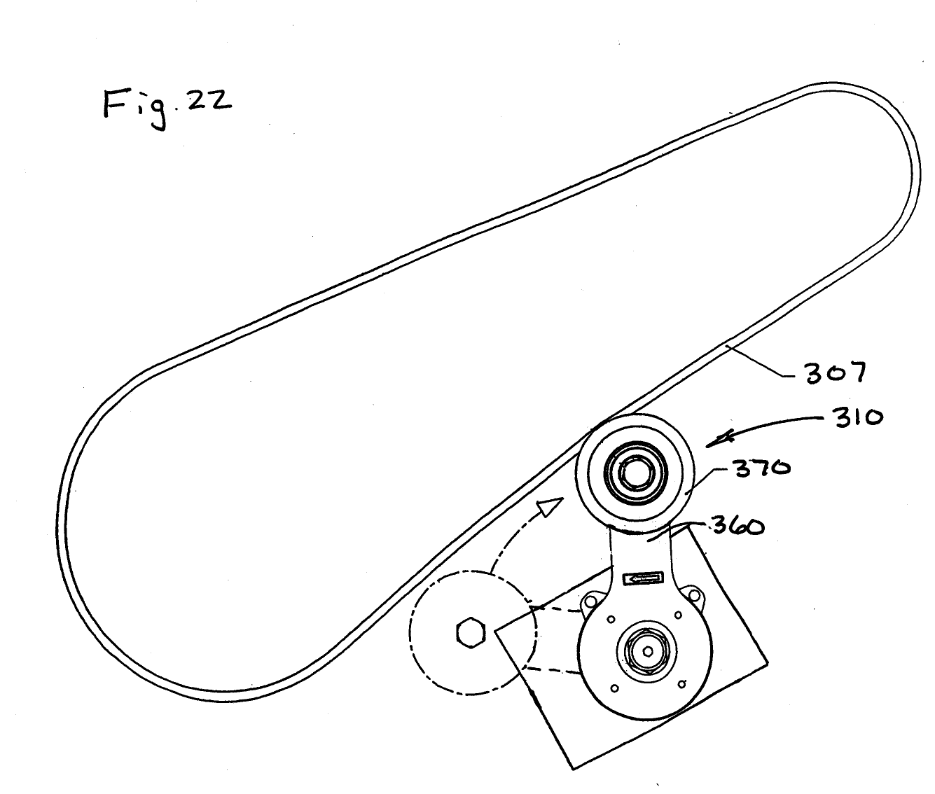

In this way, when the spring is oriented so that the housing should be turned counter-clockwise to provide torsion, the key is inserted into the pocket to show that the housing should be rotated in a counter-clockwise manner, as shown in FIG. 16. In this orientation, the recess 286 in the key 285 is aligned with the tongue 238 on the end of the spring. If one attempts to insert the key in the opposite orientation, the recess 286 does not align with the key. Instead, the wall 289 of the key engages the tongue of the spring so that the tongue impedes the key from being inserted into the pocket as shown in FIGS. 20-21. Similarly, if the spring is reversed, the tongue will project into the pocket so that the key will need to be reversed (from the perspective of FIG. 16).

Additionally, it may be desirable to lock the key in place so that it cannot fall out or be accidentally removed. Accordingly, preferably the pocket includes a shoulder that cooperates with a locking tooth or detent 288 on the leg 287 of the key 285. When the key is inserted into the pocket, the locking tooth 288 engages the shoulder 292 to prevent the key from being removed from the pocket.

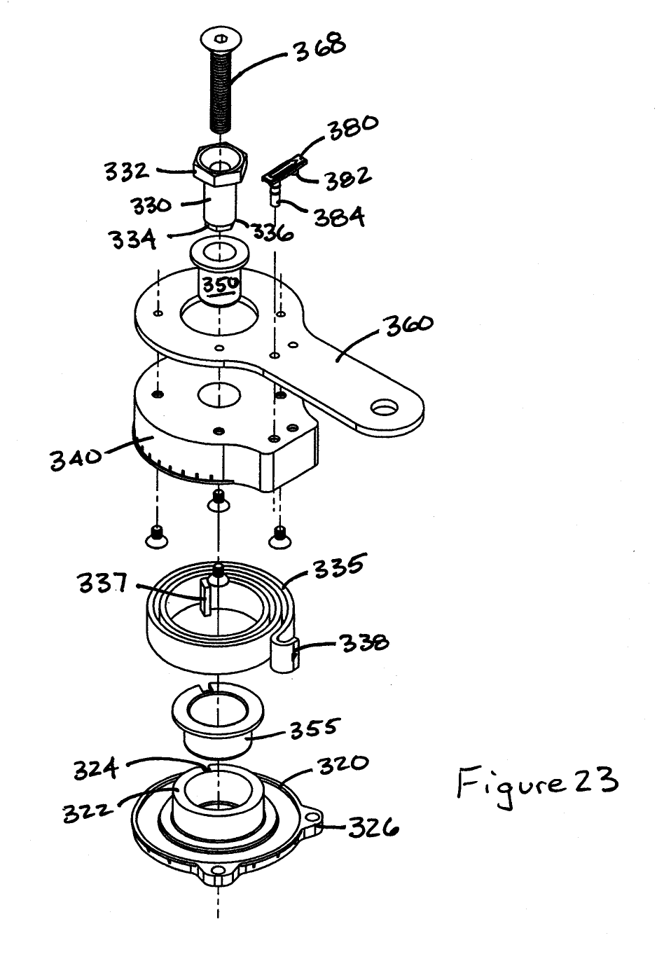

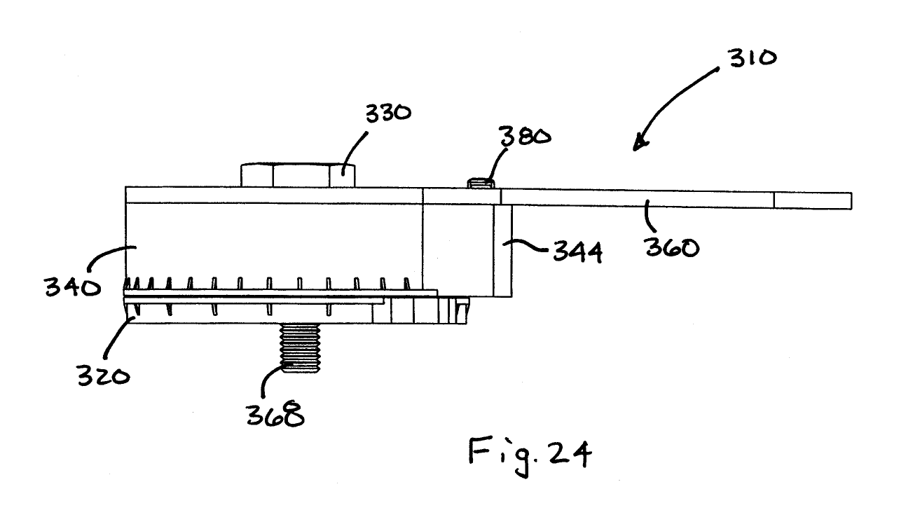

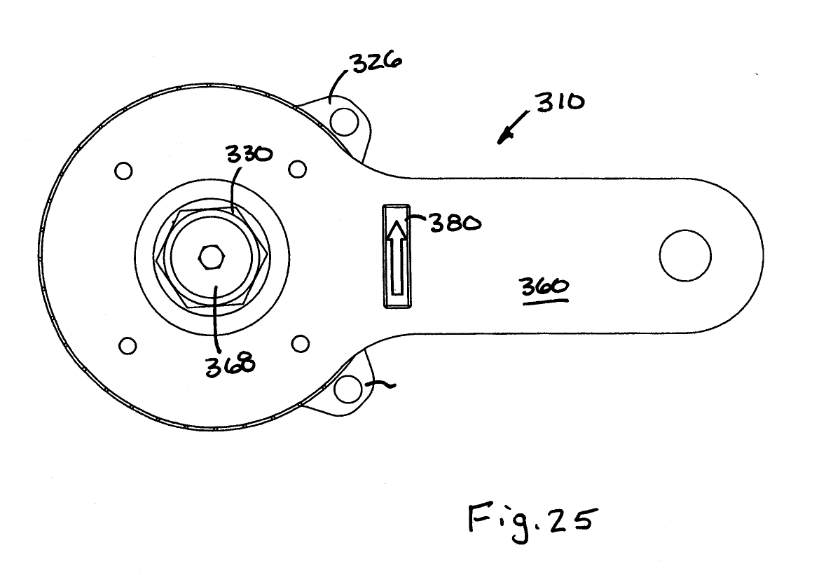

Referring now to the drawings in general, and to FIGS. 22 and 23 specifically, a further embodiment of tensioner apparatus is generally designated 310. The tensioner 310 biases an idler pulley 370 into engagement with a belt 307. The tensioner 310 includes an arm 360 removably attached to a housing 340. The arm 360 and housing 340 pivot together relative to a base and are under bias from a biasing element 335 in the housing 340. The pulley 370 is connected to the end of the arm 360 and engages the belt 307 to apply tension to the belt under the bias from the biasing element 335.

The tensioner 310 has a modular construction that allows the housing 340 to be readily assembled with arms 360 and pulleys 370 having a variety of sizes. As such, the tensioner 310 may be provided as an assembly or kit which comprises a biasing element 335, a housing 340, and a variety of lever arms 360 and pulleys 370 having different sizes. Depending on the application, a lever arm 360 and pulley 370 having appropriate dimensions may be selected and connected to the housing 340.

The modular construction of the tensioner 310 permits easy disassembly and access to the biasing element 335. Referring to FIG. 23, the tensioner 310 comprises a torsion spring 335. The spring 335 is readily removable from the housing 340 and can be reinserted in an opposite or reverse configuration to change the direction of the bias exerted on the housing 340.

Referring now to FIGS. 23, 26 and 27, the details of the tensioner will be described in greater detail. The tensioner includes a base 320 that is generally circular. As shown in FIG. 23, the base may include a pair of ears 326 projecting outwardly. Each ear 326 comprises a hole that can be used to pin the base 320 to a machine element to locate the tensioner 310 on the machine element.

The base 320 also includes a central boss or hub 322 projecting upwardly. The hub 322 is generally cylindrical is hollow, forming a cavity. A vertical slot 324 extends along the height of the hub, preferably on the outer surface of the housing. Additionally, as shown in FIG. 23, a circular recess or groove extends around the top surface of the base, adjacent the perimeter of the base. The bottom of the base 320, within the hub 322, includes a central opening 325. The shaft projects into the opening 325, and a fastener 360 extends through the shaft, and through the opening, as discussed further below.

The spring 335 is a spiral spring formed from a long piece of rectangular steel that is formed in a spiral fashion to create a plurality of overlapping convolutions. The inner end 337 of the spring 335 forms a tongue that is inserted into the slot 324 in the hub 322 of the base 320. The outer end 338 of the spring 335 also forms a tongue, which engages the housing 340 as described further below. The inner convolutions of the spring 335 have a diameter that is larger than the outer diameter of the hub 322 so that the spring is disposed around the hub 322, as shown in FIG. 27.

The housing 340 is generally cylindrical, preferably having a height that is less than its diameter. The housing 340 operates as a cap over the base, which encloses the spring 335. Accordingly, the housing is generally cylindrical, having an open lower end and a generally closed top end. The top end includes a central opening for receiving the shaft 330. A hollow cylindrical hub 341 projecting downwardly from the central opening in the top surface of the housing.

As shown in FIG. 27, the housing 340 may also include a pocket 344 extending outwardly. A slot 342 extends through the sidewall of the housing adjacent the pocket. The slot 342 is cooperable with the outer end 338 of the spring 335 to connect the spring to the housing 340. The pocket 344 encloses the end of the spring 335 and the slot 342 and forms a solid wall that strengthens the housing.

The housing 340 is configured for connecting the arm 360 to the housing. Specifically, the arm 360 comprises a first end configured to overlay the top of the housing 340. The housing and the arm include elements for connecting the arm to the housing. For instance, the first end of the arm may include a plurality of threaded holes that align with a plurality of holes in the top of the housing. In this way, the arm may be releasably connected to the housing by inserting a plurality of screws through the holes in the top of the housing so that the screws threadedly engage the threaded holes in the arm.

The housing 340 and the attached arm pivot about the shaft 330, which is connected to the base 320. The shaft is generally cylindrical, having a first end that forms an enlarged diameter head 332 and a second end 334 configured to cooperate with the opening 325 in the bottom of the base 320. The enlarged head 332 may be configured to cooperate with a tightening tool, such as a wrench, so that the tensioner can be easily rotated to increase the bias in the tensioner. Accordingly, in the present embodiment the enlarged head 332 is configured as a hex head, having opposing parallel flat surfaces that easily cooperate with a standard box wrench. However, the head of the shaft can be formed into any of a variety of shapes, preferably one that can be easily grasped by a tool to rotate the shaft.

It is desirable to connect the shaft to the base in a manner that impedes rotation of the shaft relative to the base. In this way, rotating the shaft operates to rotate the base. Furthermore, it is desirable to connect the shaft with the base in a manner that allows the shaft to be readily removed from the base so that the tensioner can be disassembled. Accordingly, in the present embodiment, the end 34 of the shaft is configured to engage the base 320. More specifically, the end has a non-circular configuration, such as a hexagonal configuration, and the opening 325 in the base is similarly configured so that the end of the shaft mates with the opening in the base.

The shaft is hollow, having a central bore, and the length of the shaft between the head 332 and the end 334 is generally cylindrical. A shoulder 336 is formed in the shaft adjacent the end 334. The shoulder 336 abuts the base 320 when the shaft end 334 is inserted in the opening 325 in the base. In this way, the shoulder operates as a stop limiting the distance that the shaft can be inserted into the housing.

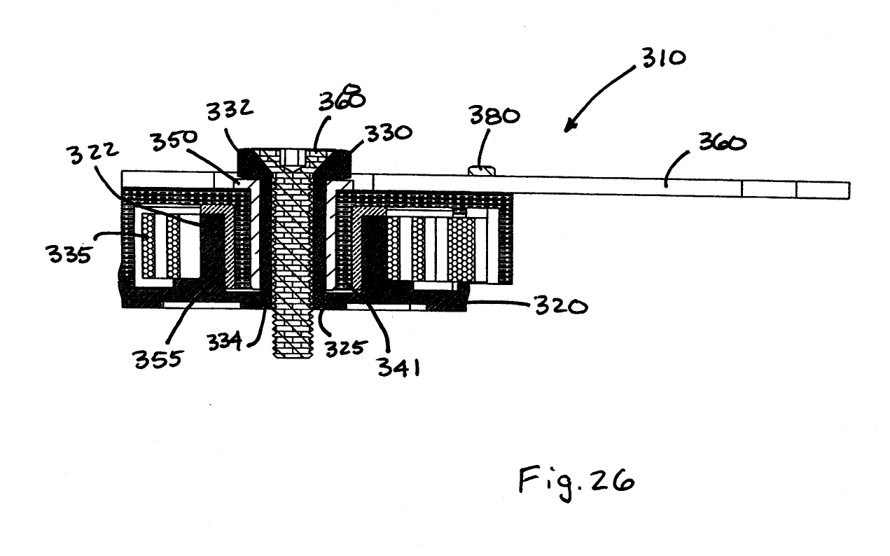

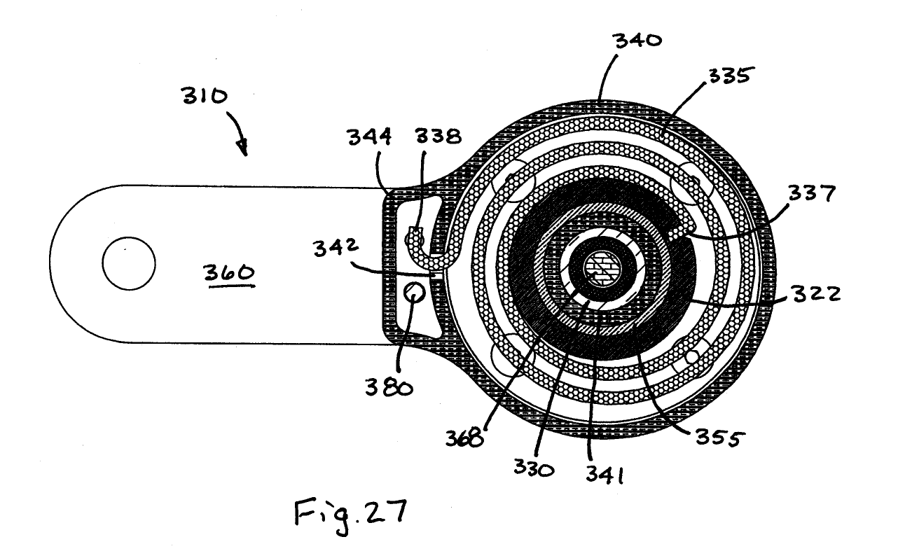

The bore of the shaft 330 is configured to receive a fastener 368 that is operable to attach the tensioner 310 to a machine element. In the illustrated embodiment, the fastener is a bolt with a flat head. The bore of the shaft is larger than the bolt 368 and the length of the fastener extends through the shaft without interfering with the bore of the shaft. in addition, it may be desirable to configure the shaft so that the head of the bolt mates with the head of the shaft. For instance, as shown in FIG. 26, the head of the shaft is countersunk to provide a tapered interior surface into which the head of the bolt mates. In this way, the bolt does not protrude from the top of the shaft, thereby reducing the overall height of the device.

In addition, preferably the head of the bolt 368 includes a surface that mates with a wrench. For instance, in the illustrated embodiment, the bolt 368 includes an internal hex socket configured to cooperates with a hex wrench.

In the foregoing description, the shaft is described as having a hollow bore. However, it may be desirable to use a shaft 330 having a threaded bore so that the fastener 368 can thread into the shaft, such as through the base 320 and into the shaft, in order to attach the tensioner to a machine element. Further, although the fastener has been described as a flat head bolt having a hex socket, the fastener can be any of a variety of types of fasteners. For instance, the fastener 368 can be a hex head bolt that protrudes upwardly from the shaft, so that the tensioner can be tensioned and tightened by engaging the shaft head 332 with a first wrench and the fastener 368 head with a second wrench, as discussed further below.

The tensioner 310 operates such that the spring 335 is connected to the housing 340 and the base 320, and the base is maintained stationary while the housing pivots about the shaft 30 in response to the load on the item being tensioned. To improve the pivoting motion of the tensioner, it may be desirable to include bushings between the various elements. For instance, as illustrated in FIGS. 23, 26 and 27, the present embodiment includes a shaft bushing 350 disposed between the shaft and the housing hub 341. The shaft bushing 350 is positioned over the shaft 330 so that the shaft bears against the interior of the shaft bushing. The shaft bushing is configured to mate with the interior of the housing hub 341, so that the interior of the housing hub bears against the external surface of the shaft bushing. In this way, the shaft bushing provides a smooth wear surface with a relatively low coefficient of friction so that the housing can pivot smoothly relative to the shaft.

The shaft bushing 350 may be a simple cylindrical liner. However, it may be desirable to utilize a bushing having a flared head, as shown in FIGS. 23 and 26. Specifically, the shaft bushing 350 may include a head that flares outwardly so that the head of the shaft bushing is disposed between the top surface of the housing and the bottom surface of the flared head 332 of the shaft 330. Configured in this way, the shaft bushing also provides a smooth wear surface with a relatively low coefficient of friction between the head of the shaft and the top surface of the housing 320.

In addition to the shaft bushing 350, it may be desirable to include a base bushing 355 to provide a smooth wear surface between the housing 340 and the base 320. Referring to FIGS. 23, 26 and 27, the base bushing is configured to be positioned within the hub 322 of the base 320, so that the external surface of the bushing confronts the interior surface of the base hub 322. More specifically, in the illustrated embodiment, the base bushing is configured to form an interference fit with the hub of the base, so that the bushing does not move relative to the base. The base bushing 355 is also configured to fit over the central hub 341 of the housing 340. Specifically, the interior cylindrical surface of the base bushing 355 confronts the external cylindrical surface of the housing hub 341. In this way, the base bushing provides a wear surface having a relatively low coefficient of friction between the housing and the base to provide a long lasting smooth pivoting action between the base and the housing.

Similar to the shaft bushing 350, the base bushing 355 may be a simple cylindrical liner type of bushing. However, it may be desirable to use a bushing having a flared head, as shown in FIGS. 23 and 26. The flared head projects outwardly from the cylindrical body of the base bushing 355, and is disposed between the inside surface of the top of the housing and the top of the base hub 322. In this way, the flared head provides a smooth wear surface between the top of the housing 340 and the top of the base hub 322.

The base bushing 355 and shaft bushing 350 are formed from materials that are softer and/or smoother than the material from which the base, housing and shaft are formed. In this way, the base, shaft and housing can be formed from materials with less regard to wear durability. For instance, the base and housing may be formed of aluminum, the shaft may be formed of steel, and the shaft bushing 350 and base bushing 355 may be formed of bronze.

Configured as described above, the tensioner 310 is assembled as follows. The base bushing 355 is press fit into the central hub 322 of the base. As shown in FIG. 23, the flared head of the base bushing 355 includes a notch that aligns with the slot 324 in the side of the base hub 322. As shown in FIG. 27, the spring 335 is placed over the base hub so that the spring wraps around the base hub, with the inner end 337 of the spring engaging the slot in the base hub. The arm is attached to the housing 340 by inserting the fastening screws 348 through the holes in the top of the housing and then into the threaded holes in the arm.

After the arm 360 is attached to the housing 340, the housing is positioned over the base 320 so that the central hub 341 of the housing is disposed within the interior of the base bushing 355. In the present embodiment, the shaft bushing 350 is press fit into the interior of the central hub 341 before the housing is placed over the base. Alternatively, the shaft bushing may be simply inserted into the bore of the central hub. The shaft 330 is then inserted into the shaft bushing so that the hex-shaped end 334 of the shaft engages the hex shaped opening 325 in the bottom of the base. The shaft 330 is inserted into the bushing until the shoulder 336 adjacent the end of the shaft abuts the bottom of the base, limiting the further insertion of the shaft. The fastener 368 is then inserted through the shaft and threaded into the machine element to assemble the tensioner together and to attach the tensioner to the machine element. When the fastener tightens down against the shaft 330, the fastener draws the shaft up against the top of the shaft bushing and the top of the housing. However, to operate most efficiently, the housing should be free to pivot relative to the shaft. Therefore, it is desirable to limit the axial force transferred from the fastener to the top of the housing. Accordingly, as illustrated in FIG. 26, the length of the shaft 330 from the shoulder 336 of the shaft to the bottom of the enlarged head of the shaft is equal to or slightly larger than the distance from the bottom of the base hub 322 to the top of the flared head of the shaft bushing 350. In this way, the shaft may operate as a spacer to limit the axial engagement between the shaft and the top of the shaft bushing when the housing is assembled. Alternatively, the shaft busing 350 may be sufficiently long so that the length from the bottom of the bushing flared head to the end of the bushing is longer than the distance from the bottom of the base hub 322 to the top of the housing. In this way, the shaft bushing may operate as a spacer to limit the axial force transferred to the housing when the fastener is tightened.

As described above, the housing 340 is mounted over the base 320 by the fastener 368 extending through the shaft and threading into a machine element. Alternatively, as described above, the bore of the shaft 330 may include a threaded portion, such that the shaft may be threaded onto a fastener attached to the machine element to attach the tensioner to the machine element, which in turn would hold the tensioner assembly together.

The tension provided by the tensioner 310 can be easily adjusted as desired for the particular application. To do so, the fastener is loosened so that the base can be rotated relative to the machine element. The tensioner is then rotated until the pulley 370 on the end of the arm 360 engages the element being tensioned, which in the present example is a belt 307. After the pulley 370 engages the belt 307, the belt will retain the arm 360 and the attached housing 340 in a generally fixed position. To increase the tension, the base is rotated further so that the base is rotated relative to the housing, thereby increasing the bias in the spring 335.

The base 320 may be rotated by rotating the shaft. Specifically, a wrench may be used to engage the enlarged head 332 of the shaft. Then, using the wrench to turn the shaft also turns the base. After the appropriate amount of tension is applied to the belt, the fastener 368 is tightened while the shaft is retained in position. In other words, after rotating the shaft into a position corresponding to the appropriate tension, the shaft is held in position to retain the tension by the wrench that was used to turn the shaft. While the shaft is held in position by the first wrench, a second wrench is used to tightened the fastener, which thereby locks the base and the shaft in position. In this way, the tension in the tensioner can be easily adjusted using two standard tools and without disassembling the tensioner.

Preferably, the biasing element is reversible so that it can provide a bias in a first direction when it is attached one way, and in a second direction when it is attached in a second way. Specifically, when the spring 335 is attached to the housing and the base so that the convolutions run in the direction shown in FIG. 27, the device is operable to provide a clockwise torsional bias (relative to the perspective of FIG. 27) when the housing is turned in a counter-clockwise direction. By flipping the torsion spring over, so that the convolutions run in the opposite direction, the device is operable to provide a counter-clockwise torsional bias when the housing is turned in a clockwise direction.

Further, the tensioner is configured and assembled so that the tensioner can be easily disassembled so that the biasing element can be reversed after the tensioner is assembled. Specifically, to reverse the spring 335, the fastener 368 is disengaged from the machine element so that the shaft 330, shaft bushing 350 and housing 340 can be removed from the base 320. The spring 335 is then removed from the base and flipped over. In other words, the bottom of the spring, which was engaging the base is flipped up so that is does not engage the base. The inner end 337 of the spring 335 engages the vertical slot 324 in the base hub 322, and the device is then re-assembled as described previously.

Since the biasing element 335 is reversible, it may be desirable to include an indicator 380 for indicating which direction to turn the shaft to provide a bias. Various elements can be used as an indicator. Preferably, the indicator includes an element with a graphical element, such as an arrow or other element indicating the proper direction for turning the housing to provide a bias.

Referring to FIG. 23, the indicator 380 has two legs or pins, a short pin 382 and a longer pin 384. The pins are configured to cooperate with two holes in the arm 360, which are aligned with two holes in the housing 340. The holes in the arm and the housing are positioned over the pocket 344 in the housing so that the pins 382, 384 on the indicator project into the pocket 344.

It is desirable to have the indicator 380 cooperate with a portion of the spring 335 so that the orientation of the spring dictates the orientation of the indicator. Specifically, preferably the indicator 380 and pocket 344 are formed so that the tongue 338 of the spring interferes with the indicator when the indicator is inserted in the wrong orientation so that the indicator cannot be improperly inserted into the pocket.

In this way, when the spring is oriented so that the housing should be turned counter-clockwise to provide torsion, the indicator is inserted through the holes in the arm and housing, and into the pocket to show that the housing should be rotated in a counter-clockwise manner, as shown in FIGS. 25 and 27. In this orientation, the short arm 382 of the indicator is aligned with the tongue 338 on the end of the spring. If one attempts to insert the indicator in the opposite orientation, the long pin 384 interferes with the spring end 338 so that the indicator cannot be completely inserted into the pocket. Similarly, if the spring is reversed, the tongue will project into the pocket so that the indicator will need to be reversed.

Additionally, it may be desirable to lock the indicator in place so that it cannot fall out or be accidentally removed. Accordingly, it may be desirable to include a locking element, such as a barb or a rib on the pins on the indicator. The rib may be formed on either or both of the pins 382, 384. In this way, when the indicator is inserted into the pocket, the ribs engage the underside of the top of housing to prevent the indicator from being removed from the pocket.

The tensioner assembly 310 may be attached to the frame of a device or onto a mounting assembly attached to a device. Referring to FIG. 22, the tensioner assembly 310 is assembled so as to engage the belt in the position shown (“engaging position”). Before the belt 307 is assembled, the tensioner assembly 310 would typically be assembled with the arm 360 pivoted into a position rotated approximately 90 degrees from the engaging position (such as that shown in phantom lines). This position (“relaxed position”) would not have any biasing load generated by the spring 335 because there would be no deflection in the spring.

When the belt is assembled, the tensioner arm 360 is rotated to the engaging position. During rotation of the arm 360, the housing 340 rotates in a radial direction around the pivot axis. By rotating the housing 340, the outer end 338 of the spring 335 moves in a radial direction because of its connection with the slot 346 in the housing 340. The inner end 337 of the spring remains fixed in contact with the slot 324 in the base 320 while the outer end 338 moves radially. As a result, movement of the outer end 338 of the spring 335 relative to the inner end 337 causes deflection in the spring. The deflection in the spring 335 generates a load which is resisted by a bias force exerted by the spring. In general, the bias force in the spring is proportional to the amount of deflection caused by rotation. The bias force is transferred through the lever arm 360 to the idler pulley 370 at the end of the arm. The idler pulley 370, in turn, pushes on the belt 307 and deflects the shape of the belt. The deflection of the belt removes the slack in the belt.

The terms and expressions which have been employed are used as terms of description and not of limitation. There is no intention in the use of such terms and expressions of excluding any equivalents of the features shown and described or portions thereof. It is recognized, therefore, that various modifications are possible within the scope and spirit of the invention. For instance, in the foregoing description, the tensioner includes a pair of bushings to improve the interface between the shaft, base and housing. In certain applications it may desirable to utilize bearing elements that incorporate ball bearing. Similarly, rather than using a separate bushing, the elements could be plated or coated with a material that provides the desired wear surface. Accordingly, the term bearing element for the shaft, base or housing is meant to include any type of liner, bushing, ball bearing, plating or coating, which provides a property or characteristic separate from the material from which the corresponding element (i.e. the shaft, base or housing) is formed. Further, the indicator has been described above as a removable element having a direction indicator printed or molded onto it. Alternatively, the directional indicator could be printed or molded onto the housing and a moveable element could cover a portion of the directional indicator depending on the orientation of the element. For instance, two arrows could be printed on the housing, one pointing in a clockwise direction, one pointing in a counter-clockwise direction. The moveable element can be configured so that in one orientation it covers the clockwise arrow, and in a second orientation it covers the counter-clockwise orientation. In yet another alternative, the moveable element could be eliminated and the indicator could be applied directly onto the spring, so that on one side of the tongue an arrow is applied directly onto the spring pointing in a first direction, and on the other side of the spring an arrow is applied pointing in the opposite direction. A still further alternative indicator comprises a directional indicator molded or printed onto the housing beneath the area where the tongue projects. In this alternative, the tongue covers up a portion of the directional indicator depending on the orientation of the spring. For instance, two opposite arrows could be printed or molded into the pocket 42. When the spring is in a first orientation, the tongue covers the second arrow, but leaves the first arrow exposed, so that the user can see the first arrow, which would thereby indicate the proper direction to turn the housing to provide tension. Similarly, when the spring is in a second orientation the tongue covers the first arrow, but leaves the second arrow exposed so that the user can see the second arrow. Further still, in the above description, the tensioner has been described as having an arm releasably connected with a housing. However, in some applications it may be desirable to provide a housing in which the arm is formed as part of the housing or is substantially permanently fixed to the housing. Accordingly, the invention incorporates variations that fall within the scope of the following claims.

I claim:

1. A tensioner for tensioning a belt, comprising:
a housing having an arm
a biasing element disposed within the housing operable to bias the arm in a first direction;
a base cooperable with the housing to enclose the biasing element;
a shaft extending through the housing and biasing element, wherein the housing is rotatable relative to the shaft and the shaft has a bore and a first end configured to mate with the base to impede rotation of the shaft relative to the base while allowing axial displacement of the shaft relative to the base; and
a fastener extending through the shaft for attaching the tensioner to a machine element.

2. The tensioner of claim 1 wherein the shaft comprises a second end having a surface adapted to cooperate with the fastener, such that tightening the fastener tightens the shaft against the base, which in turn tightens the base against the machine element.

3. The tensioner of claim 2 wherein the shaft comprises a stop for limiting the axial displacement of the shaft toward the base.

4. The tensioner of claim 3 wherein the shaft is configured such that upon tightening the fastener against the shaft, a gap remains between the second end of the shaft and the housing to permit rotation of the housing relative to the shaft.

5. The tensioner of claim 1 wherein the shaft comprises a second end configured to cooperate with a tool for tightening the tensioner.

6. The tensioner of claim 5 wherein the second end of the shaft comprises a pair of opposing parallel flat surfaces cooperable with a wrench to turn the shaft to tighten the tensioner.

7. A tensioner for tensioning a belt, comprising:
a housing having an arm
a biasing element disposed within the housing operable to bias the arm in a first direction;
a base cooperable with the housing to enclose the biasing element; and
a shaft extending through the housing and biasing element, wherein the housing is rotatable relative to the shaft and the shaft has a bore and a first end configured to mate with the base to impede rotation of the shaft relative to the base while allowing axial displacement of the shaft relative to the base.

8. The tensioner of claim 7 wherein the shaft comprises a second end having a surface adapted to cooperate with the fastener, such that tightening the fastener tightens the shaft against the base, which in turn tightens the base against the machine element.

9. The tensioner of claim 8 wherein the shaft comprises a stop for limiting the axial displacement of the shaft toward the base.

10. The tensioner of claim 9 wherein the shaft is configured such that upon tightening the fastener against the shaft, a gap remains between the second end of the shaft and the housing to permit rotation of the housing relative to the shaft.

11. The tensioner of claim 7 wherein the shaft comprises a second end configured to cooperate with a tool for tightening the tensioner.

12. The tensioner of claim 11 wherein the second end of the shaft comprises a pair of opposing parallel flat surfaces cooperable with a wrench to turn the shaft to tighten the tensioner.
